(19) United States
(12) Patent Application Publication
(10) Pub. No.: US 2021/0018248 A1
(43) Pub. Date: Jan. 21, 2021

(54) SYSTEM AND METHOD TO INHIBIT MICROBIAL GROWTH IN MASS STORAGE OF PRODUCE

(71) Applicant: Lee C. Ditzler, Livermore, CA (US)

(72) Inventor: Lee C. Ditzler, Livermore, CA (US)

(21) Appl. No.: 16/517,275

(22) Filed: Jul. 19, 2019

(51) Int. Cl. F25D 17/04; A23L 3/3445

(52) U.S. Cl. CPC F25D 17/042; F25D 2317/0413; A23L 3/3445

(57) ABSTRACT

A high-humidity and ozonated air storage system can inhibit mold growth in mass foodstuff storage while also preventing dehydration loss. The present system and method can operate at a higher humidity and temperature than conventional methods and allows for antimicrobial ozone treatment to be applied to foodstuffs in via a storage environment. In some embodiments, humidity can be controlled so that it is approximately equal to the moisture content of produce stored within a main storage area. In such embodiments, this can mitigate water loss from the produce via osmosis to the environment.

### BACKGROUND

### Technical Field

The present disclosure relates to providing a system of microbial growth-inhibiting mass storage for produce.

### Background

Foodstuffs such as fresh produce are subject to spoilage by the action of unwanted microbes such as molds and bacteria. Some examples of such produce are citrus, blueberries, kiwi fruit, apples, strawberries, nuts, onions, potatoes, and grapes. Microbes are present on the produce prior to harvesting and remain with produce as it moves from the field into processing facilities. To minimize damage to the harvested produce from the microbes, processors typically take steps such as chemical fungicide treatment, liquid wash, and cold storage for the produce. Each of these steps potentially provide remedial benefits, but also present problematic aspects.

After harvesting, many produce types can be treated with chemical fungicides and/or bactericides to inhibit microbe growth. Even after such treatment, microbe growth can cause damage, particularly as storage time is increased. Residual mold can continue to grow and can develop into large nesting molds. Fungicide and/or fumigants treatment can be relatively expensive, due at least in part to the cost of the fungicides. Further, allergies to fungicides and fumigants are common, and can adversely affect produce workers, other workers who have direct or indirect contact with the products, and eventual consumers of the products. Products treated with some chemical fungicides, fumigants, and/or bactericides are also ineligible for designation and/or description as organic produce, and thus lose access to significant markets.

After harvesting, produce can be washed with a sanitizing liquid, such as water mixed with various sanitizing agents, to remove dirt and other unwanted substances. However, the shapes of many produce items can have irregular surfaces and numerous cavities and crevices that are not effectively cleaned by this technique. Surface tension can prevent a sanitizing liquid from reaching into these small areas and inhibit adequate cleaning action in these areas. As a result, unwanted substances and microbes can remain undisturbed.

In addition to molds, bacteria such as E. Coli, Listeria and Salmonella can cause damage to fresh produce, as well as dry products such as powders, flakes and seeds. This damage can take place in contained environments such as cold storage rooms, hoppers, silos, augers, pipelines, and various enclosures.

Cold storage is used for almost all fresh harvested products to reduce spoilage from molds, yeasts, and bacteria. Fresh products can include, but are not limited to, fruits, vegetables, grapes, onions, berries, melons, and other fresh products. Freshly harvested products coming from open fields are covered with significant amounts of bacteria, molds, and yeast.

The fresh products are transported from the field to a facility where they can be drenched with fungicides, gassed with sulfur dioxide (SO₂), methyl bromide (CH₃Br), polypropylene oxide (PPO), or other chemicals prior to or just after they go into cold storage. The products are transported in containers such as boxes, totes, bins, bags, or trays stacked on pallets that are placed into the cold storage rooms. For some products, pallets are placed into pre-coolers or hydrocoolers to quickly reduce the temperature of the product, or they are placed directly into cold storage rooms. The cold storage rooms can be RA (regular atmosphere) rooms or CA (controlled atmosphere) cold storage rooms. CA cold storage removes the oxygen from the air in the cold storage room to again try to further reduce the mold growth and extend the storage time. Products may be in the cold storage for a few days or up to a year. Some products store better than others, so the time and storage is product-dependent as well as market-driven.

The present cold storage process is to put the product into the cold storage room and reduce the temperature to as close to freezing as the product will tolerate. Whether RA or CA, cold storage rooms use mechanical refrigeration to cool the room. The refrigeration process typically utilizes an evaporator located in the cold storage room where the room air is circulated across the cold evaporator using multiple large fans. The evaporator is usually operated just below freezing at approximately 28° F., which keeps the room just above freezing. In all fresh products, the water content ranges from at least 90% to 98%. The humidity of air in the cold storage room ranges from approximately 80% to 85% due to the water being frozen out of the recirculating air onto the below-freezing evaporator.

Reducing the temperature environment of cold storage can inhibit microbial growth, but this is typically implemented at high humidity levels in order to prevent damaging the produce by dehydration. At high humidity cold storage levels such as 50% to 90% relative humidity, molds can be active and can live, grow, and propagate, such as by sporulation. To maintain uniform temperature, air within cold storage units is typically continuously refrigerated and circulated, providing an ideal mechanism for spreading airborne spores throughout an entire refrigerated unit. The living and propagating microbes can then significantly damage produce inventory within the storage unit.

However, the moisture content of the fresh product is higher than the cold storage room air. Therefore, the osmotic pressure causes the water in the product to move into the cold storage room air where it is continuously removed by the below freezing evaporator. This continuous dehydration reduces the content of products that are sold by the pound as well as reducing the quality. Further, the evaporators must be defrosted every 8 hours to 24 hours, and the defrosting continuously removes water from the cold storage room.

Molds and Listeria bacteria continue to grow even at these low temperatures in RA and CA cold storage rooms. Fungicides and fumigants help reduce mold growth, but as the storage time increases their effectiveness decreases, and they are sometimes not reapplied while products are in long-term storage. Ozone is the only sanitizer that can be added continuously throughout the cold storage period. In addition, Listeria is unusual in that it grows in cold environments, but ozone will kill Listeria bacteria.

Attempts have been made to utilize ozone gas across a range of temperatures, such as 30° F. to 80° F., as an anti-microbial agent. When the gas is taken directly from an ozone generator, which produces ozone gas at 0.2% to 10% ozone by weight, corresponding respectively to 2,000 to 100,000 ppm, it has a limited effect on reducing bacteria and mold spores. The ozone gas produced is typically kept extremely dry (−40 to −100° F. dew point) in order to eliminate undesirable moisture in the ozone generating cell. Moisture passing through an ozone generating cell produces nitric acid that can cause severe damage to the ozone generating cell and downstream equipment. However, excessively dry storage environments can cause losses in produce weight due to dehydration.

Ozone gas at concentrations between approximately 0.10 ppm to 1.0 ppm has been used in cold storage rooms operating in the traditional manner. This has helped reduce spoilage, but still presents drawbacks. Cold storage facilities continue to operate with continuous background ozone, but the humidity remains approximately 75% to 85%. Mold growth continues, but the rate is slowed down, while the cold storage rooms also continue to dehydrate the stored products.

Many mold spores and spore forming microbes can tolerate high levels of dry ozone gas without being killed. However, water with ozone dissolved at levels between 0.2 and 10 ppm can be an effective killer of bacteria and mold spores that are planktonic in very short times. Mold spores open up with increased humidity, allowing the ozone to enter and kill the spores.

Therefore, what is needed are systems and methods to increase the microbe-reducing effectiveness of ozone gas application at above-freezing temperatures and humidity levels to reduces losses from dehydration in produce and dry goods storage.

### BRIEF DESCRIPTION OF THE DRAWINGS

Further details of the present system are explained with the help of the attached drawings in which:

FIG. 1 depicts a high humidity ozone gas storage system.

FIG. 2 depicts a method for storage in a high humidity ozone gas environment.

FIG. 3a graphically depicts the relationship between microbial growth and temperature.

FIG. 3b graphically depicts the relationship between dehydration loss and temperature.

FIG. 4a graphically depicts the relationship between microbial growth and humidity.

FIG. 4b graphically depicts the relationship between dehydration loss and humidity.

FIG. 5a graphically depicts the relationship between microbial growth and storage time.

FIG. 5b graphically depicts the relationship between dehydration loss and storage time.

FIG. 6 graphically depicts the relationship between ozone concentration and storage time.

FIG. 7 graphically depicts the relationship between ozone concentration and humidity.

FIG. 8 depicts an embodiment of the combined effect of ozone concentration, humidity, temperature, and time.

### DETAILED DESCRIPTION

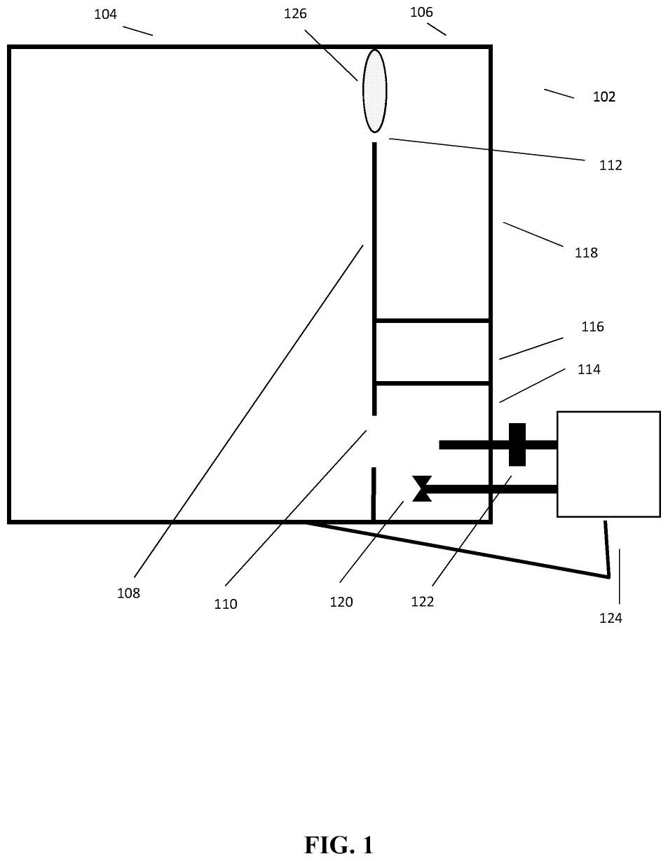

FIG. 1 depicts a high-humidity ozone gas storage system. A selectively enclosed chamber 102 can comprise a main storage area 104 and an ambient environment production area 106. As shown in FIG. 1, a main storage area 104 and an ambient environment production area 106 can be delineated by a partition 108 having a first opening 110 and a second opening 112. In some embodiments, operating temperature within a chamber 102 can be in the range of 30° F. (e.g., cold storage) to 70° F. (e.g., room temperature), or 50°±20° F., in the range of 30° F. to 45° F., or 38°±8° F., but in some embodiments can be approximately 33° F. or any other known and/or convenient temperature.

An ambient environment production area 106 can further comprise a first section 114, an evaporation unit 116, and a second section 118. In some embodiments, an evaporation unit 116 can be located between a first section 114 and a second section 118, but in other embodiments can be in any other known and/or convenient location. The temperature of an evaporator can be raise to approximately 33° F. in some embodiments, but in other embodiments can be in the range of 32° F. to 45° F., or 38°±8° F., which can prevent water in the recirculating air passing through an evaporator unit 116 from freezing out on evaporator coils. In such embodiments, water can remain in the recirculating air to maintain humidity to prevent dehydration losses to the produce.

A first opening 110 in a partition 108 can allow air to flow into a first section 114 of an ambient environment production area 106. A first section 114 of an ambient environment production area 106 can further comprise a water source 120. A water source 120 can comprise water misting devices, passive water sources, open water containers, vapor generators, or any other known and/or convenient device. An ozone gas generator 122 can be connected to a first section 114 of an ambient environment production area 106. In some embodiments, an ozone gas generator 122 can comprise a compressor, oxygen concentrate, an ozone-generating cell, or any other known and convenient operating configuration. In some embodiments, ozone gas and humidity levels can be monitored in conjunction with a feedback system 124 to maintain desired levels of each parameter. In some embodiments dry ozone gas can have a dew point in the range of −40° F. to −100° F. or 30°±70° F. and a concentration approximately in the range of 0.10 ppm to 0.13 ppm, or 0.115±0.015 ppm to 0.13 ppm, but in other embodiments can be approximately 0.125 ppm, or have any other known and/or convenient properties and concentration. Dry ozone gas and water vapor can mix in a first section 114 of an ambient environment production area 106 to produce a relative internal humidity for a chamber 102 in the range of 40% to 98%,or 69±29%, but in some embodiments can be approximately 98% and non-condensing, or any other known and/or convenient amount. As shown in FIG. 1, a fan 126 can be placed in a second partition opening 112 to facilitate moving humidified ozonated air into a main storage area 104.

Within an ambient environment production area 106, dry ozone gas and water vapor can combine to create a controlled environment of humidified ozone to interact with foodstuffs as an antimicrobial treatment. Exposure to humid conditions can cause microbe spores, such as mold spores, to open and thereby become susceptible to the effective antimicrobial action of ozonated air. At approximately 70% humidity, microbe spores begin to open, but very slowly. However, humidity above 95% results in rapid opening. The searching effect of humid ozonated air can advantageously treat irregular surfaces, cavities, and crevices found on foodstuffs that cannot be effectively reached by liquid treatments. Products such as dry powders, flakes, and seeds for which liquid treatments are undesirable can also be stored in a main storage area 104 containing humidified ozonated air to inhibit fungal growth.

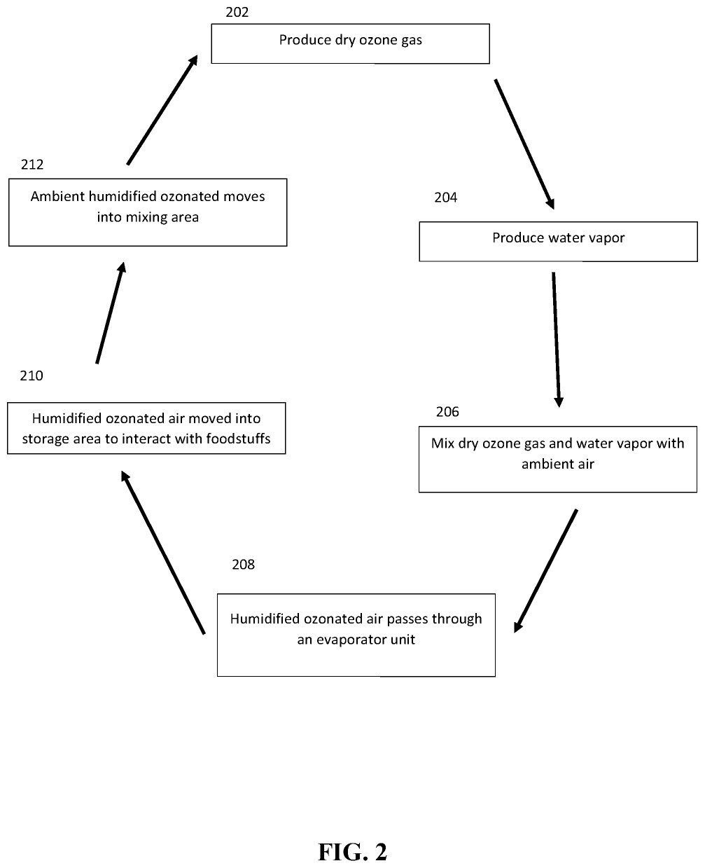

FIG. 2 depicts steps of a method for high humidity ozone gas treatment. In use, an embodiment of this process modifies the current way cold storage rooms are operated to mitigate microbial growth and product losses due to dehydration.

In step 202, dry ozone can be produced by an ozone generator 122.

In step 204, water vapor can be produced by a water source 120.

In step 206, dry ozone gas and water vapor can be introduced into and mix together in a first section 114 of an ambient environment production area 106. In order to control mold growth, ozone gas can be added at a concentration in the range of 0.050 ppm to 2.0 ppm, or 0.50±1.50 ppm, but in some embodiments can be approximately 0.125 ppm to control the mold growth. In some embodiments, ozone gas is added substantially continuously, but in other embodiments can be added at any other known and/or convenient frequency or rate. Water vapor can be added to a first section 114 of an ambient environment production area 106 via a water source 120 located in front of an evaporator unit 116. The amount of water to maintain ambient humidity in the return recirculating air can be minimal. For example, in some embodiments, only a few gallons of water are required to keep the humidity above 95%. Water vapor can be added in front of an evaporator unit 116 several times a day or at any other known and/or convenient frequency. In such embodiments, the combination of dry ozone gas and water vapor added to the ambient environment can optimize the effect of both on stored produce.

In step 208, humidified ozonated air can pass through an evaporation unit 116 into a second section 118 of an ambient environment production area 106. If an evaporator unit 116 operates at a temperature below freezing it will act as a continuous dehydrator and remove water from the air, thus reducing the humidity. Operating an evaporator unit 116 at a temperature above freezing preserves the moisture in the air and can allow the humidity in a main storage area 104 to increase up to a range between 95% to 98%, or 96.5%±1.5%. In such embodiments, maintaining a higher humidity can mitigate dehydration losses to the stored produce. Operating an evaporator 116 above freezing temperatures can also provide significant energy savings because converting water to ice requires large amounts of energy (80 calories/gram to convert water to ice at the same temperature).

In step 210, a fan unit 126 can move humidified ozonated air into a main storage area 104 to interact with foodstuffs therein. In some embodiments, a fan unit 126 can operate to produce a high air-flow rate, but in other embodiments can operate at any other known and/or convenient rate. In some embodiments, operating a fan unit 126 at full-speed maximum air flow can optimize uniform distribution of the humidified ozone gas is uniformly throughout a main storage area 104 and stored products. In conventional systems, fan speeds are uniformly distributed throughout the room and stored products. In an environment of circulating air above freezing temperature and 95%-98% humidity, mold spores will open and grow rapidly. In such embodiments, operating a fan unit 126 at a high flow rate will allow the added ozone to more effectively kill these spores.

Further, this high humidity can prevent the fresh product from dehydrating. A high humidity of 95% to 98% can prevent stored product from dehydrating shrinkage that causes loss of weight and visibly lowers the quality of the stored product by wilting and shrinkage. Many products are sold by the pound and with the dehydration mitigated, the water that would have been lost to dehydration can now be sold by the pound.

In step 212, ambient humidified ozonated air can pass through a first partition opening 110 into a first section 114 of an ambient environment production area 106 to be humidified and ozonated. This process can repeat in a substantially continuous cycle to maintain a desired ambient environment in a selectively enclosed chamber 102. In some embodiments, the described process will also remove the mold spores and bacteria from the walls, floors, totes, bins, evaporator coils, and anything other known and/or convenient items within a main storage area 104. This can prevent any mold spores, bacteria, or other microbes that are present in a main storage area 104 from transferring to the incoming fresh product once a main storage area 104 is packed out. Therefore, in some embodiments, the described process can be used to clean a main storage area 104 prior to being reloaded with product.

Stored in a high-humidity and ozonated environment, products can have extended storage times of up to 5 times longer than conventional processes without molding. This can allow a user to sell when market prices are most favorable. In some embodiments, the described process will eliminate the need for defrosting an evaporator unit 116, which will lower electrical energy use, increase cost effectiveness, and offset the cost of installation process. Dehydration mitigation can also increase cost-effectiveness. As a non-limiting example, a typical fully packed cold storage room of 150,000-250,000 cubic feet can remove a substantial amount of water from the stored product.

In produce storage, the two major threats to produce quality and yield are microbial (particularly mold) growth and dehydration losses. These levels are determined by the variables of temperature, humidity, and storage time. Ozone gas can be added to the storage environment to inhibit mold growth. In some embodiments of the present system and method, combining the relationships between these variables can optimize storage conditions.

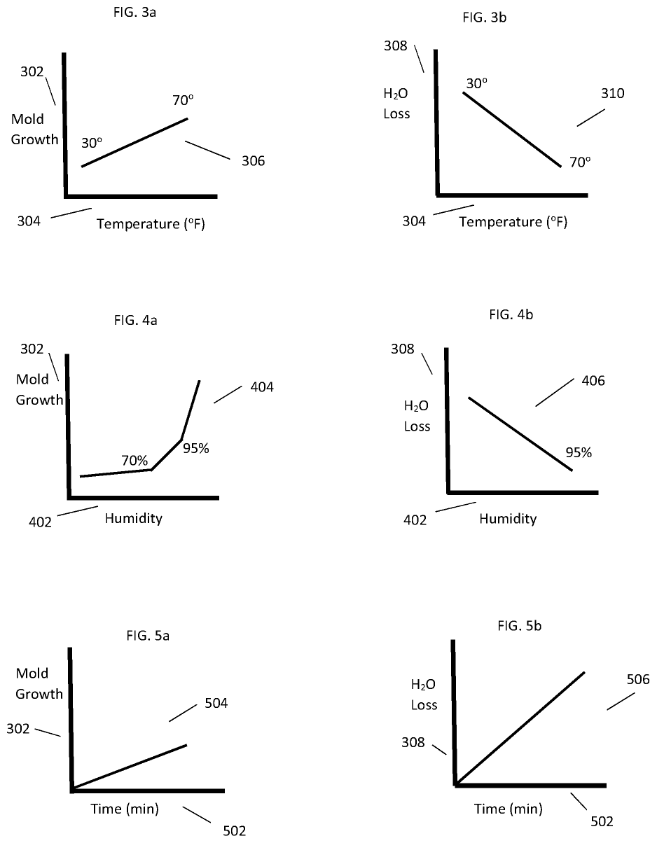

FIG. 3a graphically depicts the relationship between mold growth on the y-axis 302 and temperature on the x-axis 304. Typically, as shown by a mold growth vs. temperature curve 306, higher temperatures encourage mold growth, but only up to the point where the temperature is high enough to kill the spores. However, this is also dependent on the humidity, which must be high enough for the spores to open. Therefore, conventional practice in the art dictates that cold storage facilities 102 operate at the lowest possible temperature that will not damage the produce to slow mold growth.

FIG. 3b graphically depicts the relationship between dehydration loss on the y-axis 308 and temperature x-axis 304. As shown by a dehydration loss vs. temperature curve 310, keeping a storage facility 102 cold through the use of an evaporator unit 116 operating at temperatures at or below freezing causes the moisture in the air to evaporate out and decrease the overall humidity. Lower humidity increases dehydration loss through osmosis. Therefore, increasing operating temperature can lower evaporation losses. In some embodiments of the present system and method, operating an evaporator unit 116 at above-freezing temperatures can maintain the ambient humidity and decrease dehydration loss in the produce.

FIG. 4a graphically depicts the relationship between mold growth on the y-axis 302 and humidity on the x-axis 402. As shown by a mold grown vs. humidity curve 404, mold spores will begin to grow at humidity above 50%, and just start to open at approximately 70%. However, at humidity of approximately 95% and above, mold spores will rapidly open and grow. Therefore, maintaining a high humidity is critical to increasing the mold's exposure to the ambient atmosphere.

FIG. 4b graphically depicts the relationship between dehydration loss on the y-axis 308 and humidity on the x-axis 402. As shown by a dehydration loss vs. humidity curve 406, as humidity increases, osmotic pressure decreases, which decreases the hydration loss in the produce. This can be an additional benefit to the effect of high humidity on mold growth.

FIG. 5a graphically depicts the relationship between mold growth on the y-axis 302 and storage time on the x-axis 502. As shown by a mold growth vs. time curve 504, longer storage times generally permit more opportunity for mold growth. However, the rate of this growth is also dependent on humidity and temperature.

FIG. 5b graphically depicts the relationship between dehydration loss on the y-axis 308 and storage time on the x-axis 502. As shown by a dehydration loss vs. time curve 506, typically, the longer produce is in the cold storage environment, the more water will be lost from the produce. Therefore, storage times can be limited.

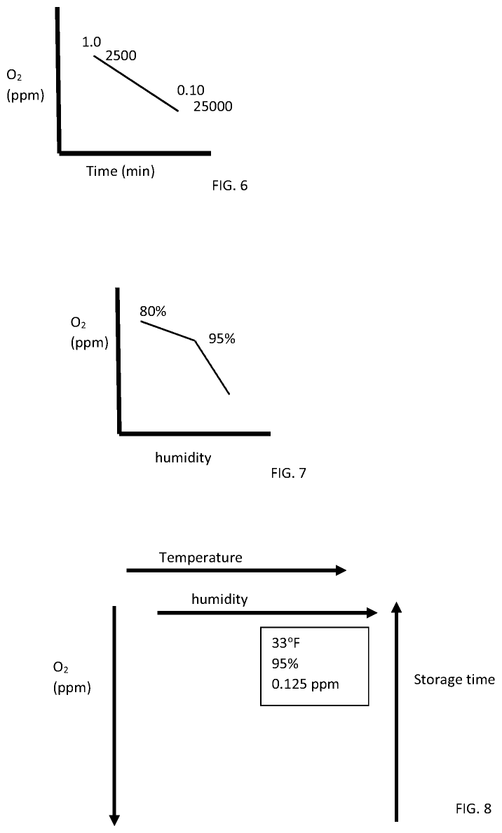

FIG. 6 graphically depicts the relationship between ozone concentration on the y-axis 602 and storage time on the x-axis 502. As shown by an ozone concentration vs. time curve 604, ozone concentrations to effectively kill mold spores is a function of time, given by the equation CT=(O₂ concentration in ppm)×(time in minutes). As a non-limiting example, the CT required to kill 99.99% of mold spores is 2500. An ozone concentration of 1.0 ppm would then require a time of 2500 minutes. For a storage time of 25,000 minutes (approximately 2 weeks), the ozone concentration would be 0.10 ppm.

FIG. 7 graphically depicts the relationship between ozone concentration on the y-axis 602 and humidity on the x-axis 402. As shown by an ozone concentration vs. humidity curve 702, higher levels of humidity allow for lower ozone concentrations to effectively kill the mold spores. Even at a humidity of approximately 80%, ozone cannot effectively kill the spores because they have not opened. However, at humidity levels of approximately 95% and higher, mold spore opening accelerates, allowing greater exposure to the ozone, and lowering the required concentration.

FIG. 8 graphically depicts an embodiment of the combined effect of ozone concentration 602, humidity 402, temperature 304, and time 502. In some embodiments, a higher operating temperature can lead to higher humidity due to eliminating the freezing out of water on an evaporator unit 116. In some embodiments, an operational combination 802 can have a temperature of approximately 33° F., humidity of approximately 95%, ozone concentration of 0.125 ppm, with storage time determined by a user.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed:

1. A system for inhibiting microbial growth in mass storage of foodstuffs comprising:
a selectively enclosed chamber,
further comprising a main storage area and an ambient environment production area delineated by a partition having a first opening and a second opening;
wherein said ambient environment production area further comprises a first section and a second section separated by an evaporation unit;
wherein said first section of an ambient environment production area further comprises a water vapor source, an ozone gas generator, and feedback monitoring and control system;
a fan unit positioned across said second opening between said second section and said main storage area;
and wherein ozone gas and water vapor are created and combine in said first section to produce a humidified ozonated antifungal ambient environment that is circulated throughout said selectively enclosed chamber.

2. The system of claim 1, wherein said selectively enclosed chamber operates with an internal temperature in the range of 30° F. to 70° F. and humidity in the range of 40% to 98%.

3. The system of claim 2, wherein said ozone gas is produced having a concentration in the range of 0.050 ppm to 2.0 ppm.

4. The system of claim 3, wherein said ozone gas concentration is approximately 0.125 ppm.

5. The system of claim 4, wherein said evaporation unit operates at a temperature in the range of in the range of 32° F. to 45° F.

6. A method for inhibiting microbial growth in mass storage of foodstuffs comprising the steps:
producing dry ozone gas;
producing water vapor;
introducing said ozone gas and water vapor into a selected space to interact with ambient air within said space to create humidified and ozonated air;
passing humidified and ozonated air through an evaporator unit operating at temperatures above the freezing point of water;
circulating said humidified and ozonated air throughout a storage chamber to interact with foodstuffs within said chamber to mitigate mold growth and dehydration of said foodstuffs;
circulating said humidified and ozonated air back into said selected space to repeat said steps in a cycle.

7. The method of claim 6, wherein said storage chamber operates with an internal temperature in the range of 30° F. to 70° F. and humidity in the range of 40% to 98%.

8. The method of claim 7, wherein the humidity level of the humidified and ozonated air is least 95%.

9. The system of claim 8, wherein said ozone gas is produced having a concentration in the range of 0.050 ppm to 2.0 ppm.

10. The system of claim 9, wherein said ozone gas concentration is approximately 0.125 ppm.

11. The system of claim 10, wherein said evaporation unit operates at a temperature in the range of in the range of 32° F. to 45° F.
